(19) United States
(12) Patent Application Publication
(10) Pub. No.: US 2009/0040671 A1
(43) Pub. Date: Feb. 12, 2009

(54) Power clamp for on-chip ESD protection

(75) Inventor: Jiong Zhang, Irvine, CA (US)

Correspondence Address: Smith Frohwein Tempel Greenlee Blaha LLC, Two Ravinia Drive, Suite 700, Atlanta, GA, 30346, US

(73) Assignee: SKYWORKS SOLUTIONS, INC., WOBURN, MA (US)

(21) Appl. No.: 12/221,286

(22) Filed: Aug. 1, 2008

Related U.S. Application Data
(60) Provisional application No. 60/964,252, filed on Aug. 10, 2007.

(51) Int. Cl. H02H 9/04

(52) U.S. Cl. 361/56

(57) ABSTRACT

According to an exemplary embodiment, a power clamp for providing on-chip ESD and mistrigger event protection includes a clamping transistor coupled between a power bus and a ground. The power clamp further includes a number of inverter stages coupled in series, where a first inverter stage has an output coupled to the clamping transistor. The power clamp further includes a turn-off resistor coupled between the power bus and an input of the first inverter. The turn-off resistor is configured to cause the clamping transistor to automatically turn off after having been turned on. The turn-off resistor determines a period of time that the clamping transistor is turned on after an ESD or mistrigger event has occurred on the power bus. The power clamp further includes a timing circuit coupled to the inverter stages. The power clamp further includes a feedback transistor coupled between a second inverter stage and the power bus.

The present application claims the benefit of and priority to a pending provisional patent application entitled “Fast-Response Active Power Clamp for On-Chip ESD Protection,” Ser. No. 60/964,252 filed on Aug. 10, 2007. The disclosure in that pending provisional application is hereby incorporated fully by reference into the present application.

### BACKGROUND OF THE INVENTION

1. Field of the Invention

The present invention generally relates to the field of integrated circuits. More particularly, the invention relates to electrostatic discharge (ESD) protection circuits for integrated circuits.

2. Background Art

Continued advances in semiconductor technology have resulted in integrated circuits (ICs) with decreasing geometries. As the ICs become miniaturized, however, they can become more susceptible to damage from an electrostatic discharge (ESD) event, which is a relatively rapid, high-current event resulting from high voltage created when electrostatic charges are rapidly transferred between bodies at different electrical potentials. If not properly contained, an ESD event can lead to either a reduction in IC performance, e.g., increased leakage current on one or more pins of the IC chip, or total circuit failure. Consequently, an ESD event can cause an undesirable increase in the overall manufacturing cost of IC chips. To provide on-chip ESD protection, some semiconductor manufacturers have provided a power clamp between power bus and ground.

One conventional power clamp for providing on-chip ESD protection is coupled between a power bus and ground and includes an inverter circuit coupled between a timing circuit and a clamping field effect transistor (FET). When an ESD event occurs on the power bus, the inverter circuit turns on the clamping FET, which provides a conductive path to ground for discharging an ESD charge on the power bus. The duration of time that the clamping FET is turned on is controlled by an RC time constant provided by a resistor in series with a capacitor in the timing circuit. Although this conventional power clamp can provide adequate ESD protection, it requires a large size resistor and capacitor, which consume an undesirably large amount of layout area on the IC chip.

Another conventional power clamp for providing on-chip ESD protection is similar to the first conventional power clamp but further includes a feedback FET coupled in series with one of the inverter stages of the inverter circuit to cause the power clamp to remain on for a longer duration, thereby significantly reducing the size of the resistor and capacitor in the RC timing circuit. However, if the clamping FET in this conventional power clamp is turned on by a mistrigger event, such as a noise spike on the power bus, the clamping FET cannot be automatically turned off after the mistrigger event. As a result, this conventional power clamp requires the power bus to be recycled off and on to turn off the clamping FET after a mistrigger event, which is undesirable.

### SUMMARY OF THE INVENTION

A power clamp for on-chip ESD protection, substantially as shown in and/or described in connection with at least one of the figures, as set forth more completely in the claims.

### BRIEF DESCRIPTION OF THE DRAWINGS

FIG. 1 illustrates a circuit diagram of a conventional exemplary power clamp for providing on-chip ESD protection.

FIG. 2 illustrates a circuit diagram of another conventional exemplary power clamp for providing on-chip ESD protection.

FIG. 3 illustrates a circuit diagram of an exemplary power clamp for providing on-chip ESD protection in accordance with one embodiment of the present invention.

FIG. 4 is a graph showing a conventional exemplary conduction curve of a clamping transistor in a conventional exemplary power clamp during and after an emulated mistrigger event.

FIG. 5 is a graph showing an exemplary conduction curve of a clamping transistor in an exemplary power clamp during and after an emulated mistrigger event, in accordance with one embodiment of the present invention.

### DETAILED DESCRIPTION OF THE INVENTION

The present invention is directed to a power clamp for on-chip ESD protection. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art.

The drawings in the present application and their accompanying detailed description are directed to merely exemplary embodiments of the invention. To maintain brevity, other embodiments of the invention which use the principles of the present invention are not specifically described in the present application and are not specifically illustrated by the present drawings.

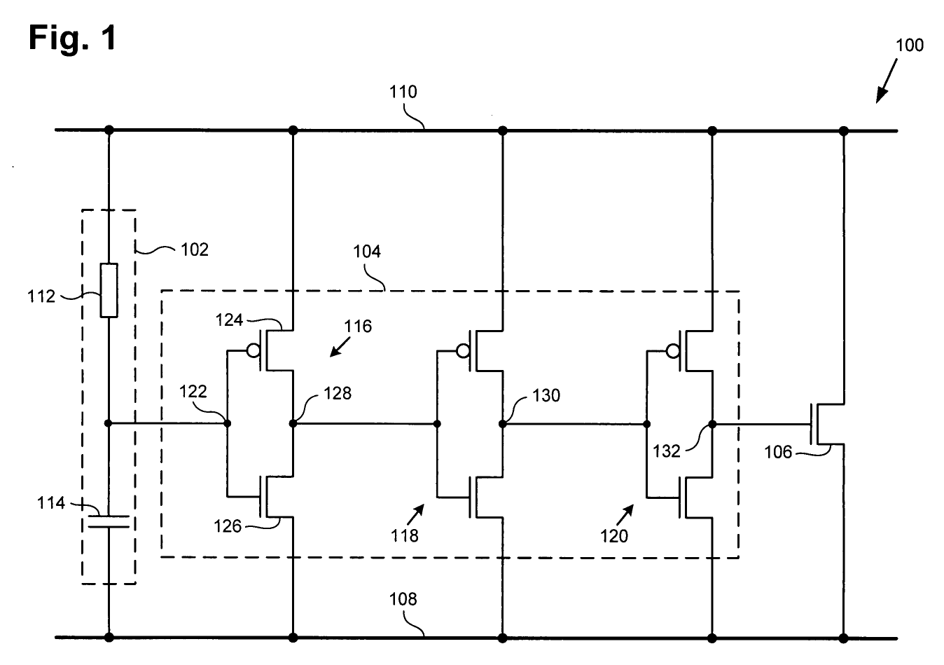

FIG. 1 shows a schematic diagram of conventional power clamp 100. In FIG. 1, conventional power clamp 100 includes timing circuit 102, inverter circuit 104, and clamping transistor 106 and is coupled between ground 108 and power bus 110, which can be a Vcc power supply bus, or Vcc bus. Conventional power clamp 100 can be situated in an IC chip (also referred to as a “semiconductor die” or simply as an “IC”) to provide on-chip ESD protection. During normal IC operation, Vcc, i.e., the supply voltage on power bus 110, can be a steady power supply voltage of, for example, between 1.0 volt and 5.0 volts. Timing circuit 102 includes resistor 112 and capacitor 114 and inverter circuit 104 includes inverter stages 116, 118, and 120, which are coupled in series between timing circuit 102 and clamping transistor 106. Inverter stage 116 includes transistor 124, which can be a P-channel FET (PFET), coupled in series with transistor 126, which can be an N-channel FET (NFET). Inverter stages 118 and 120 are substantially similar in transistor type and configuration as inverter stage 116.

As shown in FIG. 1, resistor 112 is coupled between node 122 and power bus 110 and capacitor 114 is coupled between node 122 and ground 108, which can be coupled to the substrate of the IC chip. As also shown in FIG. 1, inverter stages 116, 118, and 120 are coupled in series between node 122 and the gate of clamping transistor 106. Inverter stages 116, 118, and 120 are also coupled between power bus 110 and ground 108. Further shown in FIG. 1, the source of clamping transistor 106 is coupled to ground 108 and the drain of clamping transistor 106 is coupled to power bus 110. Clamping transistor 106 can comprise a large array of FETs, such as NFETs, coupled together in parallel, which enables it (i.e. clamping transistor 106) to discharge a large amount of current during an ESD event.

The operation of conventional power clamp 100 will now be discussed. Conventional power clamp 100 can operate in a first mode, where a steady power supply voltage is present on power bus 110, or a second mode, where no power is applied to power clamp 100. Conventional power clamp 100 can operate in the second mode, for example, when the IC chip comprising conventional power clamp 100 receives an ESD charge while being handled by a human or machine handler. In the first mode, node 122 can be charged up to approximately Vcc, i.e., the power supply voltage on power bus 110, which causes the input of inverter 116 to be pulled high. As a result, node 128 will be pulled down to ground potential (i.e. pulled low) by inverter stage 116, node 130 will be pulled high by inverter stage 118, and node 132 will be pulled low by inverter stage 120, thereby causing clamping transistor 106 (i.e. an NFET) to be turned off.

During an ESD event, a high voltage spike having a rise time of between 1.0 nanosecond (ns) and 10.0 ns can be present on power bus 110. In the first mode, the RC time constant provided by timing circuit 102, which is set by the values of resistor 112 and capacitor 114, causes node 122 to remain approximately equal to Vcc during the duration of the high voltage spike. However, node 128 will be pulled high (i.e. charged up to Vcc) through transistor 124 in inverter stage 116, node 130 will be pulled down to ground potential (i.e. ground 108) by inverter stage 118, and node 132 will be pulled high by inverter stage 120, thereby turning on clamping transistor 106 so as to provide a conductive path for discharging ESD charge from power bus 110 to ground 108. The turn-on time of clamping transistor 106 is set by the RC time constant provided by timing circuit 102, which is typically set at between 1.0 microseconds (μs) and 2.0 μs to keep clamping transistor 106 turned on for a sufficient duration so as to completely discharge the ESD charge on power bus 110.

In the second mode, the RC time constant provided by timing circuit 102 causes node 122 to remain approximately equal to approximately 0.0 volts during the duration of the high voltage spike. Similar to the first mode of operation, inverter stages 116, 118, and 120 in conventional power clamp 110 pull node 132 high to turn on clamping transistor 106 so as to discharge the ESD charge from power bus 110 to ground 108.

Although conventional power clamp 100 can provide adequate ESD protection, it requires a very large capacitor (i.e. capacitor 114) and resistor (i.e. resistor 112) to provide a required RC time constant of between 1.0 μs and 2.0 μs. As a result, capacitor 114 and resistor 112 can require an undesirably large amount of layout area on the die (i.e. the IC chip). For example, capacitor 114 and resistor 112 can occupy between 25.0 and 30.0 percent of the total layout area in conventional power clamp 100 even though clamping transistor 106 is the actual ESD discharge component.

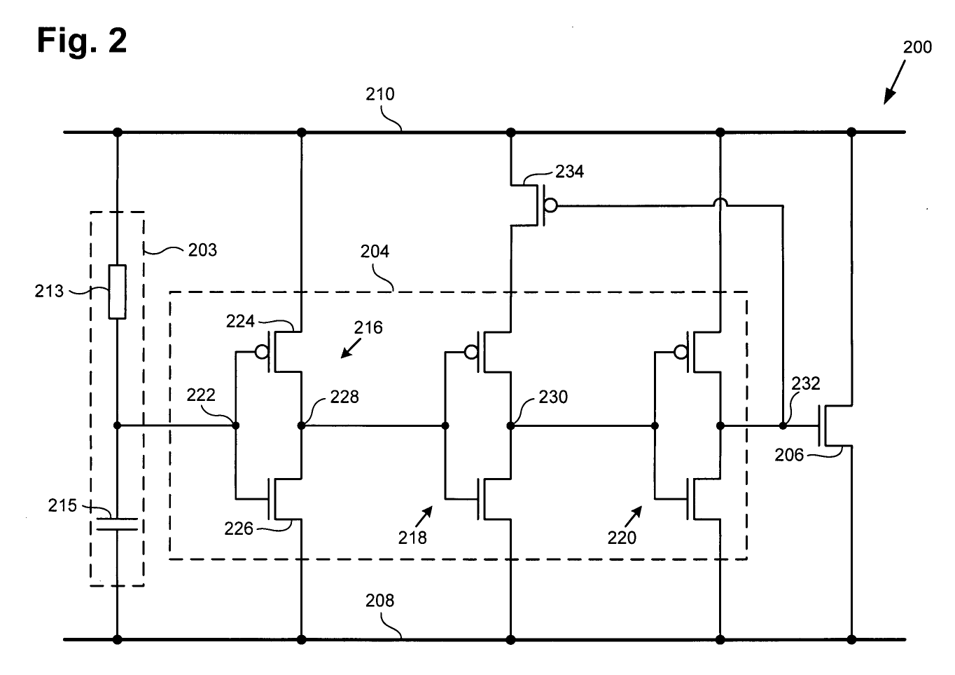

FIG. 2 shows a schematic diagram of conventional power clamp 200. In FIG. 2, inverter circuit 204, clamping transistor 206, ground 208, power bus 210, inverter stages 216, 218, and 220, transistors 224 and 226, and nodes 222, 228, 230, and 232 correspond, respectively, to inverter circuit 104, clamping transistor 106, ground 108, power bus 110, inverter stages 116, 118, and 120, transistors 124 and 126, and nodes 122, 128, 130, and 132 in FIG. 1. In FIG. 2, conventional power clamp 200 includes timing circuit 203, inverter circuit 204, clamping transistor 206, and feedback transistor 234. Timing circuit 203 includes resistor 213 and capacitor 215 and inverter circuit 204 includes inverter stages 216, 218, and 220, which are coupled in series between timing circuit 203 and clamping transistor 206.

During an ESD event on power bus 210, conventional power clamp 200 operates in a first mode, i.e., when a normal operating voltage is present on power bus 210, and in a second mode, i.e., when no voltage is present on power bus 210, in a similar manner as conventional power clamp 100 to turn on clamping transistor 206 so as to discharge an ESD charge from power bus 210 to ground 208. However, in contrast to conventional power clamp 100, conventional power clamp 200 includes feedback transistor 234, which is coupled between inverter stage 218 and power bus 210. The gate of feedback transistor 234, which can be a PFET, is coupled to the gate of clamping transistor 206 and the output of inverter circuit 204 at node 232. Thus, when clamping transistor 206 is turned on as a result of node 232 being pulled high by inverter stage 220, transistor 234 (i.e. a PFET) is turned off. As a result, node 230 is prevented from being pulled up to a sufficiently high voltage (i.e. pulled high) to cause inverter stage 220 to pull node 232 low and, thereby, turn off clamping transistor 206.

As a result of feedback transistor 234, conventional power clamp 200 requires a significantly reduced time constant of between 50.0 ns and 100 ns compared to the RC time constant required by conventional power clamp 100. As a result, capacitor 215 and resistor 213 in conventional power clamp 200 can be advantageously reduced in size by a factor of approximately 10 compared to respective capacitor 114 and resistor 112 in conventional power clamp 200. However, as discussed below, feedback transistor 234 can cause a mistrigger problem in conventional power clamp 200.

Because of feedback transistor 234, conventional power clamp 200 has two stable states: an off-state and an on-state. In the off-state, node 230 is high while node 232 is low, which turns off clamping transistor 206. In the on-state, node 230 is low while node 232 is high, which turns on clamping transistor 206. During normal IC operation, node 232 should be low (i.e. at ground potential) to cause clamping transistor 206 to be in the off-state. However, a mistrigger event, such as a noise spike on power bus 210 or ground 208, can alter the voltages at nodes 230 and 232 so as to cause clamping transistor 206 to switch to an on-state (i.e. to mistrigger). Once clamping transistor 206 mistriggers into the on-state, feedback transistor 234 is turned off, thereby providing an open circuit between the PFET in inverter stage 218 and power bus 210, which prevents clamping transistor 206 from turning off. As a result, clamping transistor 206 can consume a large amount of power while being unable to automatically turn off after the mistrigger event, which is undesirable.

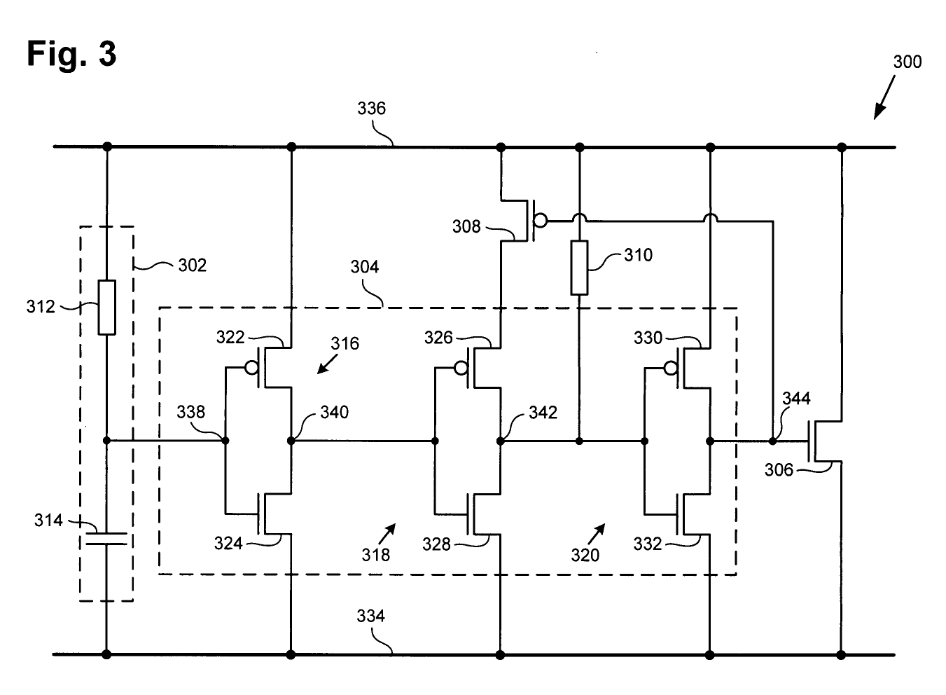

FIG. 3 shows a schematic diagram of an exemplary power clamp in accordance with one embodiment of the present invention. In FIG. 3, power clamp 300, which is an active power clamp, includes timing circuit 302, inverter circuit 304, clamping transistor 306, feedback transistor 308, and turn-off resistor 310. Timing circuit 302 includes resistor 312 and capacitor 314 and inverter circuit 304 includes inverter stages 316,318, and 320, which are coupled in series between timing circuit 302 and clamping transistor 306. Inverter stage 316 includes transistors 322 and 324, inverter stage 318 includes transistors 326 and 328, and inverter stage 320 includes transistors 330 and 332. In the present embodiment, transistors 322, 326, and 328 can be PFETs and transistors 324, 328, and 332 can be NFETs. However, in other embodiments, inverters stages 316, 318, and 320 might be implemented with different types of transistors. In one embodiment, inverter circuit 304 might include more than three inverter stages.

Power clamp 300 can be situated in an IC chip (also referred to as a “semiconductor die” or simply as an “IC”) to provide on-chip ESD protection. Power clamp 300 is coupled between ground 334, which can be coupled to the semiconductor substrate in the IC chip, and power bus 336, which can be a Vcc power supply bus, or Vcc bus, in the IC in the present embodiment. The supply voltage (i.e. Vcc) on power bus 336 can be equal to approximately 3.3 volts in the present embodiment. In other embodiments, the supply voltage on power bus 336 can be between 1.0 volt and 5.0 volts. In one embodiment, power bus 336 can be a Vdd power supply bus.

As shown in FIG. 3, resistor 312 is coupled between node 338, which is the input of inverter stage 316, and power bus 336 and capacitor 314 is coupled between node 338 and ground 334. The value of resistor 312, which can be referred to as “R,” and the value of capacitor 314, which can be referred to as “C,” determine time constant “Trc,” which is equal to R*C. In the present embodiment, Trc can be equal to approximately 100.0 ns. However, in other embodiments, Trc might be less than or greater than 100.0 ns. Also shown in FIG. 3, the gates of transistors 322 and 324 are coupled to node 338, the source of transistor 322 is coupled to power bus 336, the drains of transistors 322 and 324 are coupled to node 340, which provides the output of inverter stage 316 and the input of inverter stage 318, and the source of transistor 324 is coupled to ground 334.

Further shown in FIG. 3, the gates of transistors 326 and 328 are coupled to node 340, the source of transistor 328 is coupled to ground 334, the drains of transistors 326 and 328 are coupled to node 342, which provides the output of inverter stage 318 and the input of inverter stage 320, the source of transistor 326 is coupled to the drain of transistor 308, and the source of transistor 308 is coupled to power bus 336. Also shown in FIG. 3, turn-off resistor 310 is coupled between node 342 and power bus 336. In the present embodiment, turn-off resistor 310 can comprise a long channel PMOSFET having a bulk terminal and source coupled to power bus 336 and drain and gate coupled to node 342. In other embodiments, turn-off resistor 310 can be a different type of resistor. The resistance of turn-off resistor 310 can be optimized for a particular technology that is being utilized in the IC chip, such as, for example, 0.13 micron technology. In the present embodiment, turn-off resistor can have a resistance equal to or greater than 1.0 mega ohm.

Also shown in FIG. 3, the gates of transistors 330 and 332 are coupled to node 342, the sources of transistor 332 and clamping transistor 306 are coupled to ground 334, the drains of transistors 330 and 332 and the gate of clamping transistor 306 are coupled to node 344, and the source of transistor 330 and the drain of clamping transistor 306 are coupled to power bus 336. Clamping transistor 306 can comprise a large array of FETs, such as NFETs, coupled together in parallel, which enables it (i.e. clamping transistor 306) to discharge a large amount of current during an ESD event, such as a high voltage spike on power bus 336.

The operation of power clamp 300 will now be discussed. Power clamp 300 can operate in a first mode, where a steady power supply voltage, such as Vcc, is present on power bus 336, or in a second mode, where no power is applied to power clamp 300. Power clamp 300 can operate in the second mode, for example, when the IC chip comprising power clamp 300 receives an ESD charge while being handled by a human or machine handler. When power clamp 300 is operating in the first mode, node 338 can be charged up to voltage approximately equal to Vcc, i.e., the power supply voltage on power bus 336, which causes the input of inverter state 316 to be pulled high. As a result, node 340 will be pulled down to ground potential (i.e. pulled low) by inverter stage 316, node 342 will be pulled high by inverter stage 318, and node 344 will be pulled low by inverter stage 320, thereby causing clamping transistor 306 (e.g. an NFET) to be turned off.

During an ESD event, a high voltage spike having a fast rise time of between 1.0 ns and 10.0 ns can be present on power bus 336, for example. When power clamp 300 is operating in the first mode when the ESD event occurs on power bus 336, the RC time constant set by the values of resistor 312 and capacitor 314 (i.e. Trc) prevents the voltage at node 338 from increasing due to the high voltage spike. The high voltage spike causes node 340 to be pulled high (i.e. charged up) through transistor 322, which causes node 342 to be pulled low (i.e. pulled down to the potential of ground 334, which can be approximately 0.0 volts) by inverter stage 318. As a result, node 344 will be pulled high by inverter stage 320 to turn on clamping transistor 306 so as to discharge the ESD charge from power bus 336 to ground 334. When node 344 is pulled high, feedback transistor 308, which is coupled in series with transistor 326 of inverter stage 318, is turned off, which prevents node 342 from being pulled high and causing node 344 to be pulled low by inverter 320. As a result, clamping transistor 306 remains turned on during the entire duration of the ESD event.

After the ESD charge has been discharged through clamping transistor 306, turn-off resistor 310 can charge up node 342 at the input of inverter 320 to a voltage approximately equal Vcc (i.e. the supply voltage on power bus 336), which causes node 344 to be pulled low by inverter stage 320 so as to turn off clamping transistor 306. Thus, turn-off resistor 310 can determine the turn-on time of clamping transistor 306, i.e., the period of time that clamping transistor 306 remains turned on after an ESD event has occurred on power bus 336. By appropriately adjusting the resistance of turn-off resistor 310, power clamp 300 can be designed to have a desired turn-on time, which corresponds to the turn-on time of clamping transistor 306.

When power clamp 300 is operating in the second mode when an ESD event, such as a high voltage spike, occurs on power bus 336, node 338 will remain at a voltage of approximately 0.0 volts (i.e. ground potential) for a period of time determined by Trc, which can be approximately 100.0 ns in the present embodiment. The high voltage spike on power bus 336 causes node 340, which is at the input of inverter 318, to charge up to a high voltage through transistor 322. As a result, node 342 is pulled down to ground potential by inverter stage 318 and node 344 is pulled high by inverter stage 320, thereby turning clamping transistor on so as to discharge the ESD charge on power bus 336 to ground 334.

Moreover, during the first mode, when a mistrigger event, such as a noise spike having a very fast rise time, occurs on power bus 336 during normal operation of the IC chip, the RC time constant provided by timing circuit 302 (i.e. Trc) causes node 338 at the input of inverter 316 to remain at a voltage approximately equal to Vcc (i.e. the supply voltage on power bus 336). Node 340 will be pulled high (i.e. charged up to a high voltage) through transistor 322, which causes node 342 to be pulled low (i.e. pulled down to approximately 0.0 volts) by inverter stage 318. As a result, the output of inverter stage 320 at node 344 will be pulled high, thereby turning on clamping transistor 306. When the mistrigger event occurs, turn-off resistor 310 can charge up node 342 to a voltage approximately equal to Vcc within a designated period of time, which can be between approximately 1.0 μs and 2.0 μs in one embodiment. When node 342 has been charged up to Vcc by turn-off resistor 310, node 344 is pulled low by inverter stage 320, thereby turning off clamping transistor 306. Thus, turn-off resistor 310 can be configured to automatically turn off clamping transistor 306 after a predetermined period of time after it (i.e. clamping transistor 306) has been turned on by a mistrigger event, which can be, for example, a noise spike on power bus 336. Turn-off resistor 310 can also operate in a similar manner as discussed above to turn off clamping transistor 306 after a mistrigger event such as a noise spike on ground 334 has caused it (i.e. clamping transistor 306) to be turned on.

Thus, in contrast to conventional power clamp 200, the invention's power clamp can automatically turn off the clamping transistor after it has been turned on by a mistrigger event, such as a noise spike on the power bus or on ground. Also, the invention's power clamp 300 requires an RC time constant (i.e. Trc) of only approximately 100.0 ns. In contrast, conventional power clamp 100 requires an RC time constant of between 1.0 μs and 2.0 μs. Thus, the invention's power clamp can achieve a significant reduction in the RC layout area, e.g., the layout area required by resistor 312 and capacitor 314, compared to the RC layout area required by resistor 112 and capacitor 114 in conventional power clamp 100. As a result, the invention's power clamp can achieve a significant reduction in total required layout area on the die compared to conventional power clamp 100.

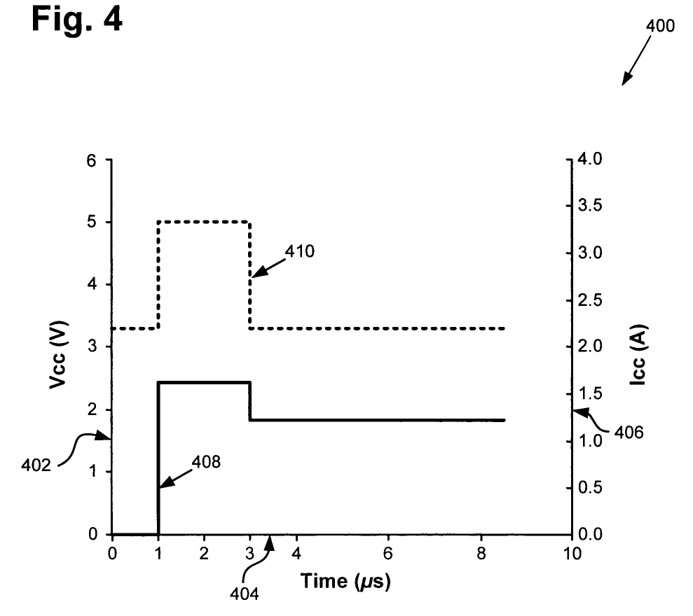

FIG. 4 shows graph 400 including a conventional exemplary conduction curve of clamping transistor 206 in conventional power clamp 200 during and after an emulated mistrigger event. Graph 400 includes voltage axis 402, time axis 404, current axis 406, conventional conduction curve 408, and step signal 410. In graph 400, conventional conduction curve 408 corresponds to the conduction of clamping transistor 206 in conventional power clamp 200 during and after step signal 410, which is used to emulate a mistrigger event on power bus 210 in FIG. 2.

In the example shown in graph 400, prior to the addition of step signal 410 to emulate a mistrigger event, such as noise, on power bus 210, clamping transistor 206 was turned off and a stable power supply voltage of approximately 3.3 volts was provided on power bus 210. In the example shown in graph 400, step signal 410 having a fast rise time of 1.0 ns was added on power bus 210 at approximately 1.0 μs and removed at approximately 3.0 μs. As a result of the fast rise time of step signal 410, clamping transistor 206 was turned on and began conducting current at approximately 1.0 μs, as indicated by conventional conduction curve 408. However, as shown in the example in graph 400, since conventional power clamp 300 does not have a mechanism to automatically turn off clamping transistor 206 after a mistrigger event, clamping transistor 206 continued to conduct current after step signal 410 was removed at approximately 3.0 μs.

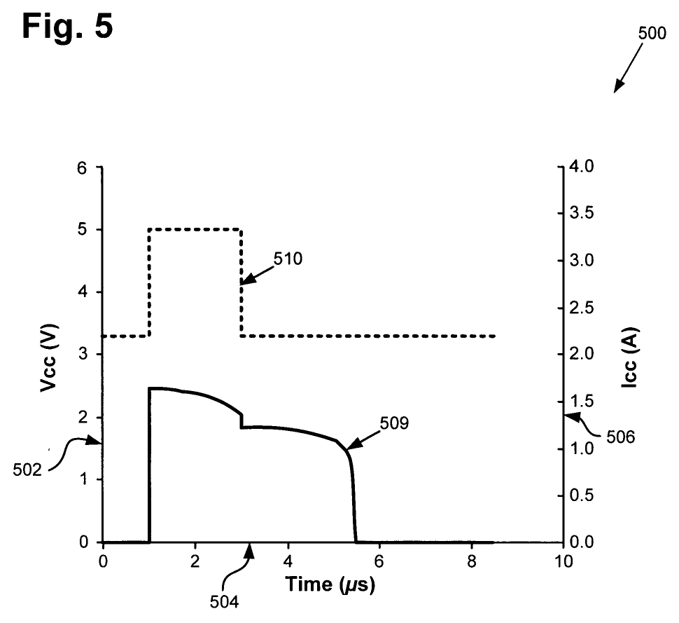

FIG. 5 shows graph 500 including an exemplary conduction curve of clamping transistor 306 in power clamp 300 during and after an emulated mistrigger event, in accordance with one embodiment of the present invention. Graph 500 includes voltage axis 502, time axis 504, current axis 506, conduction curve 509, and step signal 510. In graph 500, conduction curve 509 corresponds to the conduction of clamping transistor 306 in an embodiment of the invention's power clamp 300 during and after step signal 510, which is used to emulate a mistrigger event on power bus 336 in FIG. 3.

In the example shown in graph 500, prior to the addition of step signal 510 to emulate a mistrigger event, such as noise, on power bus 336, clamping transistor 306 was turned off and a stable power supply voltage of approximately 3.3 volts was provided on power bus 336. In the example shown in graph 500, step signal 510 having a fast rise time of 1.0 ns was added on power bus 336 at approximately 1.0 μs and removed at approximately 3.0 μs. As a result of the fast rise time of step signal 510, clamping transistor 306 was turned on and began conducting current at approximately 1.0 μs, as indicated by conduction curve 509. As shown in the example in graph 500, clamping transistor 306 continued to conduct current for approximately 2.0 μs after step signal 510 was removed at approximately 3.0 μs. Thus, as a result of turn-off resistor 310, clamping transistor 306 in an embodiment of the invention's power clamp 300 automatically turned off after step signal 510 (i.e. the emulated mistrigger event) was removed.

Thus, as discussed above, the invention advantageously provides an active power clamp with a turn-off resistor that can be configured to automatically turn off a clamping transistor in the power clamp after the clamping transistor has been turned on by an ESD event or a mistrigger event. Thus, the invention's active power clamp can provide effective on-chip ESD protection while advantageously reducing power consumption by automatically turning off after an ESD event or a mistrigger event.

From the above description of the invention it is manifest that various techniques can be used for implementing the concepts of the present invention without departing from its scope. Moreover, while the invention has been described with specific reference to certain embodiments, a person of ordinary skill in the art would appreciate that changes can be made in form and detail without departing from the spirit and the scope of the invention. Thus, the described embodiments are to be considered in all respects as illustrative and not restrictive. It should also be understood that the invention is not limited to the particular embodiments described herein but is capable of many rearrangements, modifications, and substitutions without departing from the scope of the invention.

1. A power clamp for providing ESD and mistrigger event protection in a power bus, said power clamp comprising:
a clamping transistor coupled between said power bus and a ground;
a plurality of inverter stages driving said clamping transistor;
a turn-off resistor coupled to at least one inverter stage in said plurality of inverter stages, said turn-off resistor configured to cause said clamping transistor to automatically turn off after having been turned on.

2. The power clamp of claim 1, wherein said turn-off resistor is coupled between an input of said at least one inverter stage and said power bus.

3. The power clamp of claim 1, wherein said turn-off resistor determines a period of time that said clamping transistor remains turned on after an ESD event has occurred on said power bus.

4. The power clamp of claim 1, wherein said turn-off resistor determines a period of time that said clamping transistor remains turned on after a mistrigger event has occurred on said power bus.

5. The power clamp of claim 1 further comprising a timing circuit coupled to said plurality of inverter stages.

6. The power clamp of claim 1 further comprising a feedback transistor coupled between a selected inverter stage of said plurality of inverter stages and said power bus.

7. The power clamp of claim 6, wherein said feedback transistor has a gate coupled to a gate of said clamping transistor.

8. The power clamp of claim 1, wherein said turn-off resistor has a resistance equal to or greater than 1.0 mega ohm.

9. A power clamp for providing ESD and mistrigger event protection in a power bus, said power clamp comprising:
a clamping transistor coupled between said power bus and a ground;
a plurality of inverter stages coupled in series, a first inverter stage of said plurality of inverter stages having an output coupled to said clamping transistor;
a turn-off resistor coupled between said power bus and an input of said first inverter stage;
said turn-off resistor configured to cause said clamping transistor to automatically turn off after having been turned on.

10. The power clamp of claim 9, wherein said turn-off resistor determines a period of time that said clamping transistor remains turned on after an ESD event has occurred on said power bus.

11. The power clamp of claim 9, wherein said turn-off resistor determines a period of time that said clamping transistor remains turned on after a mistrigger event has occurred on said power bus.

12. The power clamp of claim 9 further comprising a timing circuit coupled to said plurality of inverter stages.

13. The power clamp of claim 9 further comprising a feedback transistor coupled between a second inverter stage of said plurality of inverter stages and said power bus, said second inverter stage having an output coupled to said input of said first inverter stage.

14. The power clamp of claim 13, wherein said feedback transistor has a gate coupled to said output of said first inverter stage.

15. The power clamp of claim 9, wherein said turn-off resistor has a resistance equal to or greater than 1.0 mega ohm.

16. A semiconductor die comprising a power clamp for providing ESD and mistrigger event protection in a power bus, said power clamp comprising:
a clamping transistor coupled between said power bus and a ground;
a plurality of inverter stages driving said clamping transistor;
a turn-off resistor coupled to at least one inverter stage in said plurality of inverter stages, said turn-off resistor configured to cause said clamping transistor to automatically turn off after having been turned on.

17. The semiconductor die of claim 16, wherein said turn-off resistor is coupled between an input of said at least one inverter stage and said power bus.

18. The semiconductor die of claim 16, wherein said turn-off resistor determines a period of time that said clamping transistor remains turned on after an ESD event or a mistrigger event has occurred on said power bus.

19. The semiconductor die of claim 16 further comprising a feedback transistor coupled between a selected inverter stage of said plurality of inverter stages and said power bus.
